(19) United States
(12) Patent Application Publication
(10) Pub. No.: US 2006/0291125 A1
(43) Pub. Date: Dec. 28, 2006

(54) Driving method for an electrophoretic display with high frame rate and low peak power consumption

(75) Inventors: Guofu Zhou, Best (NL); Alex Henzen, Voortstraat (NL); Jan van de Kamer, Heerenweg (NL); Mark T. Johnson, De Geeigieter (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, Eindhoven (NL)

(21) Appl. No.: 10/570,843

(22) PCT Filed: Aug. 30, 2004
(86) PCT No.: PCT/IB04/51607

§ 371 Date: Mar. 6, 2006

Related U.S. Application Data
(60) Provisional application No. 60/501,125, filed on Sep. 8, 2003.
(60) Provisional application No. 60/545,318, filed on Feb. 17, 2004.

(51) Int. Cl. H01H 73/00

(52) U.S. Cl. 361/115

(57) ABSTRACT

An image is updated on a bi-stable display (310) such as an electrophoretic display by using voltage waveforms (600, 620, 640, 660; 700, 720, 740, 760; 800, 820, 840, 860) that are configured such that voltage changes are constrained to a subset of possible voltage levels during specific frame times. The specific frame times may occur during datadependent portions of the waveforms, such as a reset portion (R) and/or a drive portion (D, D1, D2). Due to the reduced voltage swing, the supply voltage can be reduced, resulting in reduced power consumption. Moreover, the frame time (FT′) can be shortened during the data-dependent portions of the waveforms to increase the greyscale accuracy and number of grey levels. At other frames times, the voltage levels can vary throughout the full range of possible voltage levels, while a standard frame time (FT) is used.

The invention relates generally to electronic reading devices such as electronic books and electronic newspapers and, more particularly, to a method and apparatus for providing set of driving waveforms for driving a bi-stable display such as an electrophoretic display while reducing power consumption.

Recent technological advances have provided “user friendly” electronic reading devices such as e-books that open up many opportunities. For example, electrophoretic displays hold much promise. Such displays have an intrinsic memory behavior and are able to hold an image for a relatively long time without power consumption. Power is consumed only when the display needs to be refreshed or updated with new information. So, the power consumption in such displays is very low, suitable for applications for portable e-reading devices like e-books and e-newspaper. Electrophoresis refers to movement of charged particles in an applied electric field. When electrophoresis occurs in a liquid, the particles move with a velocity determined primarily by the viscous drag experienced by the particles, their charge (either permanent or induced), the dielectric properties of the liquid, and the magnitude of the applied field. An electrophoretic display is a type of bi-stable display, which is a display that substantially holds an image without consuming power after an image update.

For example, international patent application WO 99/53373, published Apr. 9, 1999, by E Ink Corporation, Cambridge, Mass., US, and entitled Full Color Reflective Display With Multichromatic Sub-Pixels, describes such a display device. WO 99/53373 discusses an electronic ink display having two substrates. One is transparent, and the other is provided with electrodes arranged in rows and columns. A display element or pixel is associated with an intersection of a row electrode and column electrode. The display element is coupled to the column electrode using a thin film transistor (TFT), the gate of which is coupled to the row electrode. This arrangement of display elements, TFT transistors, and row and column electrodes together forms an active matrix. Furthermore, the display element comprises a pixel electrode. A row driver selects a row of display elements, and a column or source driver supplies a data signal to the selected row of display elements via the column electrodes and the TFT transistors. The data signals correspond to graphic data to be displayed, such as text or figures.

The electronic ink is provided between the pixel electrode and a common electrode on the transparent substrate. The electronic ink comprises multiple microcapsules of about 10 to 50 microns in diameter. In one approach, each microcapsule has positively charged white particles and negatively charged black particles suspended in a liquid carrier medium or fluid. When a positive voltage is applied to the pixel electrode, the white particles move to a side of the microcapsule directed to the transparent substrate and a viewer will see a white display element. At the same time, the black particles move to the pixel electrode at the opposite side of the microcapsule where they are hidden from the viewer. By applying a negative voltage to the pixel electrode, the black particles move to the common electrode at the side of the microcapsule directed to the transparent substrate and the display element appears dark to the viewer. At the same time, the white particles move to the pixel electrode at the opposite side of the microcapsule where they are hidden from the viewer. When the voltage is removed, the display device remains in the acquired state and thus exhibits a bi-stable character. In another approach, particles are provided in a dyed liquid.

For example, black particles may be provided in a white liquid, or white particles may be provided in a black liquid. Or, other colored particles may be provided in different colored liquids, e.g., white particles in blue liquid.

Other fluids such as air may also be used in the medium in which the charged black and white particles move around in an electric field (e.g., Bridgestone SID2003—Symposium on Information Displays. May 18-23, 2003, —digest 20.3). Colored particles may also be used.

To form an electronic display, the electronic ink may be printed onto a sheet of plastic film that is laminated to a layer of circuitry. The circuitry forms a pattern of pixels that can then be controlled by a display driver. Since the microcapsules are suspended in a liquid carrier medium, they can be printed using existing screen-printing processes onto virtually any surface, including glass, plastic, fabric and even paper. Moreover, the use of flexible sheets allows the design of electronic reading devices that approximate the appearance of a conventional book.

However, the power consumed by the electronic display can become unacceptably high due to large, rapid changes in the voltage applied to the pixels as a frame is updated, especially with higher frame rates. Higher frame rates may be used at higher temperatures, or to increase the number of grey levels or the greyscale accuracy, for instance.

The invention addresses the above and other issues by providing a method and apparatus for providing set of driving waveforms for driving a bi-stable display such as an electrophoretic display while reducing power consumption.

In a particular aspect of the invention, a method provides a set of voltage waveforms for updating at least a portion of a bi-stable display in successive frame periods. The method includes accessing data defining the set of voltage waveforms for the successive frame periods, and generating the set of voltage waveforms for driving the at least a portion of the bi-stable display during the successive frame periods according to the accessed data Over a duration of the successive frame periods, each of the voltage waveforms spans a first range of values. Moreover, at least one of the successive frame periods is time-aligned with a data-dependent portion of each of the voltage waveforms that spans a second range of values that is a subset of the first range of values.

A related electronic reading device and program storage device are also provided.

In the drawings:

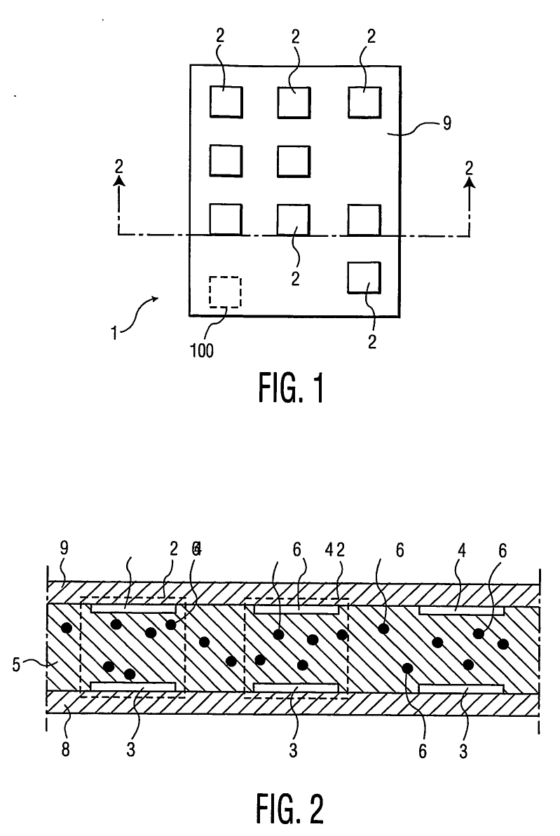

FIG. 1 shows diagramatically a front view of an embodiment of a portion of a display screen of an electronic reading device;

FIG. 2 shows diagramatically a cross-sectional view along 2-2 in FIG. 1;

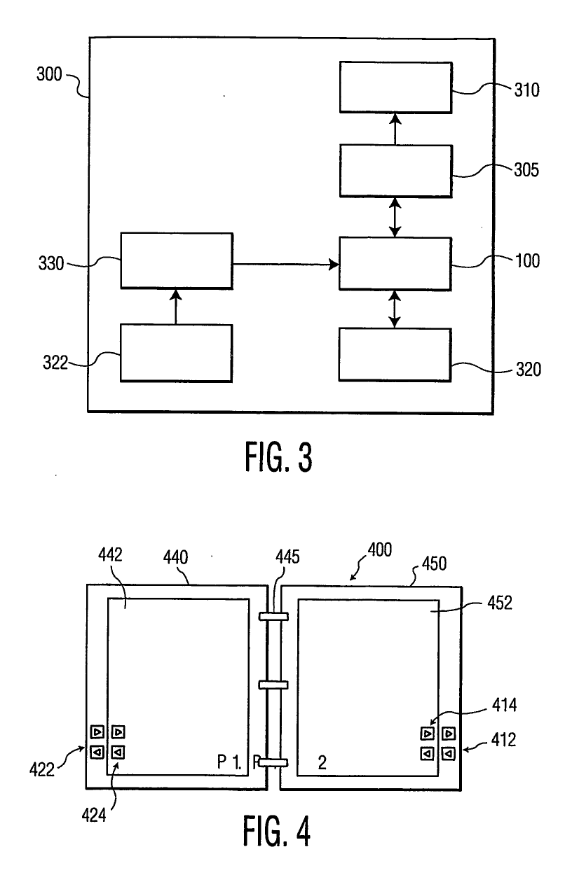

FIG. 3 shows diagramatically an overview of an electronic reading device;

FIG. 4 shows diagramatically two display screens with respective display regions;

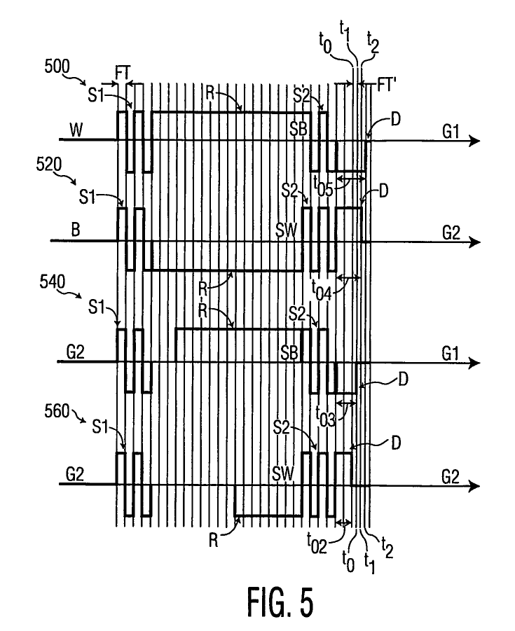

FIG. 5 illustrates example waveforms for image transitions where a high peak power is expected between t0 and t1, and between t1 and t2;

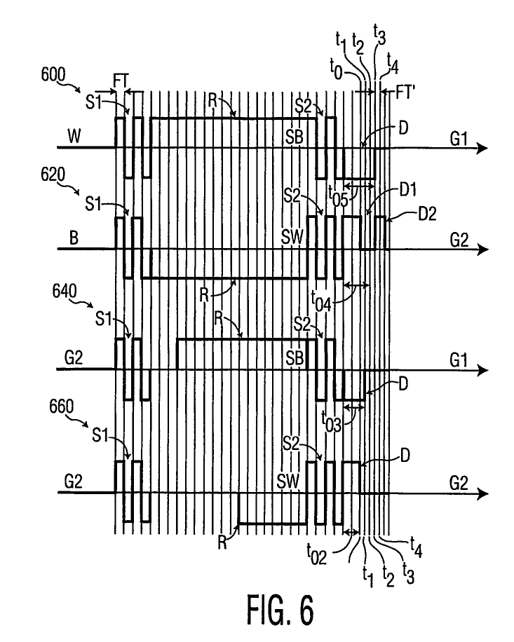

FIG. 6 illustrates example waveforms for image transitions where a part of the drive pulse in the transition from B to G2 is delayed by three frame periods, in accordance with a first embodiment of the invention;

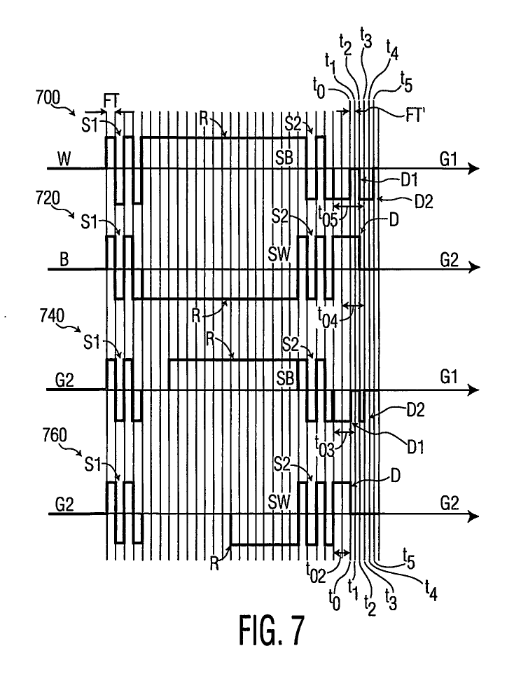

FIG. 7 illustrates example waveforms for image transitions where a part of the drive pulse in the transitions from W to G1, and from G2 to G1, is delayed by two frame periods, in accordance with a second embodiment of the invention; and

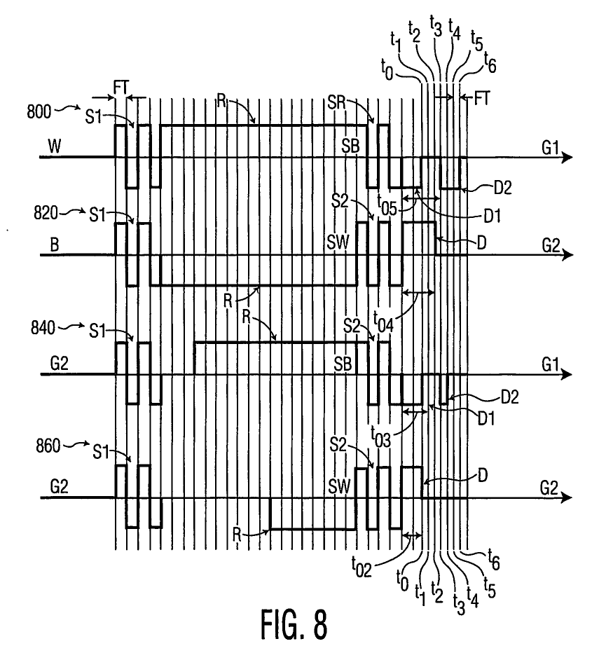

FIG. 8 illustrates example waveforms for image transitions where a part of the drive pulse in the transitions from W to G1, and from G2 to G1, is delayed by three frame periods, in accordance with a third embodiment of the invention.

In all the Figures, corresponding parts are referenced by the same reference numerals.

Each of the following is incorporated herein by reference:

European patent application EP 02078823.8, entitled “Electrophoretic Display Panel”, filed Sep. 16, 2002 (docket no. PHNL 020844);

European patent application EP 03100133.2, entitled “Electrophoretic display panel”, filed Jan. 23, 2003 (docket no. PHNL 030091);

European patent application EP 02077017.8, entitled “Display Device”, filed May 24, 2002, or WO 03/079323, Electrophoretic Active Matrix Display Device”, published Feb. 6, 2003 (docket no. PHNL 020441); and

European patent application EP 03101705.6, entitled “Electrophoretic Display Unit”, filed Jun. 11, 2003 (docket no. PHNL 030661).

FIGS. 1 and 2 show the embodiment of a portion of a display panel 1 of an electronic reading device having a first substrate 8, a second opposed substrate 9 and a plurality of picture elements 2. The picture elements 2 may be arranged along substantially straight lines in a two-dimensional structure. The picture elements 2 are shown spaced apart from one another for clarity, but in practice, the picture elements 2 are very close to one another so as to form a continuous image. Moreover, only a portion of a full display screen is shown. Other arrangements of the picture elements are possible, such as a honeycomb arrangement. An electrophoretic medium 5 having charged particles 6 is present between the substrates 8 and 9. A first electrode 3 and second electrode 4 are associated with each picture element 2. The electrodes 3 and 4 are able to receive a potential difference. In FIG. 2, for each picture element 2, the first substrate has a first electrode 3 and the second substrate 9 has a second electrode 4. The charged particles 6 are able to occupy positions near either of the electrodes 3 and 4 or intermediate to them. Each picture element 2 has an appearance determined by the position of the charged particles 6 between the electrodes 3 and 4. Electrophoretic media 5 are known per se, e.g., from U.S. Pat. Nos. 5,961,804, 6,120,839, and 6,130,774 and can be obtained, for instance, from E Ink Corporation.

As an example, the electrophoretic medium 5 may contain negatively charged black particles 6 in a white fluid. When the charged particles 6 are near the first electrode 3 due to a potential difference of, e.g., +15 Volts, the appearance of the picture elements 2 is white. When the charged particles 6 are near the second electrode 4 due to a potential difference of opposite polarity, e.g., −15 Volts, the appearance of the picture elements 2 is black. When the charged particles 6 are between the electrodes 3 and 4, the picture element has an intermediate appearance such as a grey level between black and white. An application-specific integrated circuit (ASIC) 100 controls the potential difference of each picture element 2 to create a desired picture, e.g. images and/or text, in a full display screen.

The full display screen is made up of numerous picture elements that correspond to pixels in a display.

FIG. 3 shows diagramatically an overview of an electronic reading device. The electronic reading device 300 includes the display ASIC 100. For example, the ASIC 100 may be the Philips Corp. “Apollo” ASIC E-ink display controller. The display ASIC 100 controls the one or more display screens 310, such as electrophoretic screens, via an addressing circuit 305, to cause desired text or images to be displayed. The addressing circuit 305 includes driving integrated circuits (ICs). For example, the display ASIC 100 may act as a voltage source that provides voltage waveforms, via an addressing circuit 305, to the different pixels in the display screen 310. The addressing circuit 305 provides information for addressing specific pixels, such as row and column, to cause the desired image or text to be displayed. The display ASIC 100 causes successive pages to be displayed starting on different rows and/or columns. The image or text data may be stored in a memory 320, which represents one or more storage devices, and accessed by the ASIC 100 as needed. One example is the Philips Electronics small form factor optical (SFFO) disk system, in other systems a non-volatile flash memory could be utilized. The electronic reading device 300 further includes a reading device controller 330 or host controller, which may be responsive to a user-activated software or hardware button 322 that initiates a user command such as a next page command or previous page command.

The reading device controller 330 may be part of a computer that executes any type of computer code devices, such as software, firmware, micro code or the like, to achieve the functionality described herein. Accordingly, a computer program product comprising such computer code devices may be provided in a manner apparent to those skilled in the art The reading device controller 330 may further comprise a memory (not shown) that is a program storage device that tangibly embodies a program of instructions executable by a machine such as the reading device controller 330 or a computer to perform a method that achieves the functionality described herein. Such a program storage device may be provided in a manner apparent to those skilled in the art.

The display ASIC 100 may have logic for periodically providing a forced reset of a display region of an electronic book, e.g., after every x pages are displayed, after every y minutes, e.g., ten minutes, when the electronic reading device 300 is first turned on, and/or when the brightness deviation is larger than a value such as 3% reflection. For automatic resets, an acceptable frequency can be determined empirically based on the lowest frequency that results in acceptable image quality. Also, the reset can be initiated manually by the user via a function button or other interface device, e.g., when the user starts to read the electronic reading device, or when the image quality drops to an unacceptable level.

The ASIC 100 provides instructions to the display addressing circuit 305 for driving the display 310 by accessing information stored in the memory 320.

The invention may be used with any type of electronic reading device. FIG. 4 illustrates one possible example of an electronic reading device 400 having two separate display screens. Specifically, a first display region 442 is provided on a first screen 440, and a second display region 452 is provided on a second screen 450. The screens 440 and 450 may be connected by a binding 445 that allows the screens to be folded flat against each other, or opened up and laid flat on a surface. This arrangement is desirable since it closely replicates the experience of reading a conventional book.

Various user interface devices may be provided to allow the user to initiate page forward, page backward commands and the like. For example, the first region 442 may include on-screen buttons 424 that can be activated using a mouse or other pointing device, a touch activation, PDA pen, or other known technique, to navigate among the pages of the electronic reading device. In addition to page forward and page backward commands, a capability may be provided to scroll up or down in the same page. Hardware buttons 422 may be provided alternatively, or additionally, to allow the user to provide page forward and page backward commands. The second region 452 may also include on-screen buttons 414 and/or hardware buttons 412. Note that the frame around the first and second display regions 442, 452 is not required as the display regions may be frameless. Other interfaces, such as a voice command interface, may be used as well. Note that the buttons 412, 414; 422, 424 are not required for both display regions. That is, a single set of page forward and page backward buttons may be provided. Or, a single button or other device, such as a rocker switch, may be actuated to provide both page forward and page backward commands. A function button or other interface device can also be provided to allow the user to manually initiate a reset.

In other possible designs, an electronic book has a single display screen with a single display region that displays one page at a time. Or, a single display screen may be partitioned into or two or more display regions arranged, e.g., horizontally or vertically. Furthermore, when multiple display regions are used, successive pages can be displayed in any desired order. For example, in FIG. 4, a first page can be displayed on the display region 442, while a second page is displayed on the display region 452. When the user requests to view the next page, a third page may be displayed in the first display region 442 in place of the first page while the second page remains displayed in the second display region 452. Similarly, a fourth page may be displayed in the second display region 452, and so forth. In another approach, when the user requests to view the next page, both display regions are updated so that the third page is displayed in the first display region 442 in place of the first page, and the fourth page is displayed in the second display region 452 in place of the second page. When a single display region is used, a first page may be displayed, then a second page overwrites the first page, and so forth, when the user enters a next page command. The process can work in reverse for page back commands. Moreover, the process is equally applicable to languages in which text is read from right to left, such as Hebrew, as well as to languages such as Chinese in which text is read column-wise rather than row-wise.

Additionally, note that the entire page need not be displayed on the display region. A portion of the page may be displayed and a scrolling capability provided to allow the user to scroll up, down, left or right to read other portions of the page. A magnification and reduction capability may be provided to allow the user to change the size of the text or images. This may be desirable for users with reduced vision, for example.

Problem Addressed Pulse width-modulation (PWM) has been found to be a low cost technique for driving a bi-stable display such as an electrophoretic display, because of the low price of the drivers. Using a driving waveform, the greyscale accuracy is limited by the minimum frame time, which is usually a standard time of 20 ms. However, a shorter frame time of about 8 ms has recently been achieved.

A bi-stable display such as an electrophoretic display is based on the motion of charged particles under an external electric field. The switching time is temperature dependent because of the change of the particle mobility and/or the viscosity of the fluid with temperature. With present E-ink materials, the switching time decreases with increasing temperature, and the driving voltage waveforms developed for room temperature must be extended to the higher temperatures. A possible approach is to reduce the frame time (as discussed in European patent application EP 02078823.8, docket no. PHNL020844) by, for example, scaling, where a very short frame time is requested. In addition, a still shorter frame time is needed to achieve an increased number of grey levels, and to further improve the greyscale accuracy. However, the use of a relatively short frame time results in higher power consumption. In particular, when the source driver integrated circuit (IC) has to operate in a full range of voltage values in the same short frame scanning, an unacceptably high peak power will be requested. The invention addresses this problem.

Proposed Solution A technique is discussed for reducing power consumption in a bi-stable device while achieving an accurate greyscale, increasing the number of greyscale levels, while using a high frame rate.

In one possible approach, driving waveforms for various greyscale image transitions are intentionally aligned in time such that voltage changes are constrained to a subset range of possible voltage values during one or more frames. In other words, a full range voltage swings between maximum and minimum values are avoided. For example, when the range of possible voltages is between −15 V and +15 V in the waveforms, variations from −15 V to +15 V, or from +15 V to −15 V, are avoided for specific portions of the waveforms. Instead, variations between −15 V and 0 V, or between 0 V and +15 V, are allowed for the specific portions of the voltage waveforms. These waveform portions may include data-dependent portions of the waveform in which a relatively shorter frame period is used. By reducing the voltage swing or span within one or more frames, power consumption is significantly reduced. In particular, the peak power consumed by a bi-stable device is proportional to the square voltage-change, i.e., P∝C×(ΔV)², where C denotes capacitance. More specifically, the peak power consumed is the product of the capacitance×frequency×voltage swing×supply voltage. The supply voltage for the IC or chip that supplies voltage to pixels in the bi-stable device, such as in the addressing circuit 305, must be at least equal to the voltage swing and may be 30 V, for example. The voltage swing or span is the range of possible voltages used, e.g., 30 V (+15 V-(−15V)). Thus, reducing the voltage swing by half, to 15V, reduces power consumption by half during specific frames.

However, in accordance with one aspect of the invention, the supply voltage can be reduced according to the reduced voltage swing, to e.g., 15 V. This reduces power consumption to one-fourth its original amount. As a result of the reduced supply voltage and voltage swing, a frame time of as short as one-fourth of the standard frame time may be used while maintaining the same low power consumption. This is important since the availability of the short frame time is particularly useful in improving the greyscale accuracy at higher temperatures and for increasing the number of grey levels.

The invention is applicable to any driving scheme, including rail-stabilized driving schemes, in which the driving pulses include reset pulses and greyscale driving pulses. A reset pulse is a voltage pulse that moves particles in the bi-stable display to one of the two extreme optical states, and the greyscale driving pulse is a voltage pulse that sends the display/pixel to the desired final optical state. In the following embodiments, the rail-stabilized driving as disclosed in the above-referenced European patent application EP 03100133.2 (docket no. PHNL030091) is used for explaining possible implementations of the invention, although other driving schemes may be used.

FIG. 5 illustrates example waveforms for image transitions where a high peak power is expected between t0 and t1, and between t1 and t2. Example waveforms are illustrated for image transitions from White (W) to Dark grey (G1) (waveform 500), Black (B) to Light grey (G2) (waveform 520), G2 to G1 (waveform 540) and G2 to G2 (waveform 560) using rail-stabilized driving. These examples represent a subset of the sixteen waveforms that are required to update an image for an electrophoretic display with the four indicated brightness levels. With rail-stabilized driving, a reset pulse (R) is used that has a duration that is proportional to the distance that the particles need to move between two electrodes, e.g., from the white state (W) to the black state (SB), in waveform 500. The reset pulse (R) may have an over-reset duration that is used for improving the image quality. Over-reset pulses are discussed in the above-referenced co-pending European patent application 03100133.2 (docket no. PHNL030091). In waveform 500, the subsequent drive pulse (D) has an energy that is sufficient to drive the display from the black state (SB) to the final state, which is the dark grey (G1) state. The energy of a pulse is the product of voltage amplitude and duration.

Generally, a number of such waveforms are stored in memory in the electronic device and used for driving the pixels in the display. The waveforms can be used for updating a portion of the display such as one or more pixels, or the entire display. The vertical lines indicate frame boundaries. The frame time or period is the time between frame boundaries, or the inverse of the frame rate, which can vary in the waveforms. The waveforms generally start and terminate at the same time. As discussed, a shorter frame time of, e.g., 8-10 ms, can be used for selected portions of the waveform, e.g., to increase accuracy and provide more greyscale levels, while a longer, standard frame time of, e.g., 20 ms, may be used for other portions of the waveforms.

Each waveform 500, 520, 540 and 560 includes four portions: first shaking pulses (S1), a reset portion (R), second shaking pulses (S2) and a drive portion (D). SB and SW denote a black or white state, respectively, reached via a reset pulse. Both the first and second shaking pulses can be implemented by data-independent “hardware” shaking, where all pixels on the display receive the shaking signal simultaneously, independent of data on individual pixels. This can be seen in that the shaking pulses S1 and S2 are time aligned among the different waveforms. With hardware shaking, the power consumption can be minimized. Shaking pulses are discussed in the above-referenced co-pending European patent application 02077017.8 or WO 03/079324 (docket no. PHNL020441). Integration of shaking pulses and over-reset pulses in the drive waveforms significantly improves the greyscale accuracy.

However, the reset (R) and drive pulses (D) are examples of data-dependent portions of the waveforms 500, 520, 540 and 560 since they are supplied to individual pixels, frame by frame, and therefore depend on the data that defines the image of a frame. The reset pulse (R) is less sensitive to the choice of the frame time than the greyscale drive pulse (D).

In fact, the greyscale drive pulse (D) is extremely sensitive to the choice of the frame time because the greyscale accuracy in each image transition (e.g., W to G1, B to G2, etc.) is mainly determined by the drive pulse frame time. We therefore focus on the drive portion in the following discussion. However, the choice of frame time is important to any data dependent portion of a voltage waveform that is applied to a bi-stable display.

In the image transitions of FIG. 5, the greyscale drive pulse (D) time period (to) varies from two to five frame times or periods. In particular, for waveform 500, t_{D5}=five FT, including two standard frame times (FT) and three short frame times (FT′). For waveform 520, t_{D4}=four FT, including two standard frame times (FT) and two short frame times (FT′). For waveform 540, t_{D3}=three FT, including two standard frame times (FT) and one short frame time (FT′). For waveform 560, t_{D2}=two FT, including two standard frame times (FT).

However, for some time-aligned frames, some of the greyscale drive pulses have positive voltages and others have negative voltages. Each drive portion or pulse (D) includes two standard frame times (FT), which already have a relatively low power consumption (although the source driver operates at negative and positive voltages). One can even consider these frames as a single long “standard” frame using a single scan, keeping the power consumption even lower. In the frame periods between t₀ and t₁, and between t₁ and t₂, a single scan with the minimum (short) frame time FT′ is required during which both negative and positive voltages have to be supplied by the source driver, resulting in an unacceptably high peak power. For example, between t₀ and t₁, the waveforms 500, 520, 540 and 560 request −15 V, +15 V, −15 V, and 0 V, respectively.

Since the minimum and maximum voltages, −15 V and +15 V, respectively, are applied in the same frame, when updating different pixels, the voltage source must switch between its minimum and maximum outputs when addressing the different pixels in the same frame, resulting in high power consumption. The waveforms discussed below address this problem by avoiding a full range voltage swing in one or more specific frames for specific data-dependent portions of the voltage waveforms that are aligned in time, e.g., in the same one or more frames.

FIG. 6 illustrates example waveforms for image transitions where a part of the drive pulse in the transition from B to G2 is delayed by three frame periods, in accordance with a first embodiment of the invention. Waveform 600 provides an image transition from White (W) to Dark grey (G1), waveform 620 provides an image transition from Black (B) to Light grey (G2), waveform 640 provides an image transition from G2 to G1, and waveform 660 provides an image transition from G2 to G2. The same waveforms as used in FIG. 5 are presented, but now part of the greyscale drive pulse in the B to G2 transition (waveform 620) is delayed by three short frames (FT′). In particular, the drive portion of waveform 620 includes first and second drive portions D1 and D2, respectively, where D2 follows D1 after the delay.

Between t₀ and t₁, a single scan with a frame time FT′ is used. However, now the voltage levels applied to different pixels in a common frame do not vary throughout the full (first) range of −15 V to +15 V. Instead, the voltage levels only vary in the subset (second) range of −15 V to 0 V. Specifically, between t₀ and t₁, the waveforms 600, 620, 640 and 660 request −15 V, 0 V, −15 V and 0 V. Similarly, in the frame time between t1 and t₂, and between t₂ and t₃, the waveforms 600, 620, 640 and 660 request −15 V, 0 V, 0 V, and 0 V.

Again, the voltage levels only vary in the subset range of −15 V to 0 V. In the frame time between t₃ and t₄, the waveforms 600, 620, 640 and 660 request 0 V, +15 V, 0 V, and 0 V.

Here, the voltage levels only vary in the subset (third) range of 0 V and +15 V. In fact, for each of the short frame times (FT′), the voltage swing is constrained to one of the subset voltage ranges.

In the examples discussed, the possible voltage values varied between a minimum of −15 V and a maximum of +15 V, where an intermediate value of 0 V is also used.

However, the invention can be used with any range of voltages, and the voltage range need not be centered about zero. For example, the minimum and maximum voltages might both have positive values, e.g., from +10 V to +40 V. Moreover, it is possible to constrain the voltage levels to two or more subset ranges within the range of possible values. The subset ranges may be contiguous, noncontiguous, and/or overlapping. For example, two subset ranges may be used, e.g., −15 V to 0 V, and 0 V to +15 V, that are contiguous and that span a first range of values of−15 V to +15 V. Since the range of voltage values that is applied to the pixels is reduced, the supply voltage to the voltage source can also be reduced, as discussed, resulting in reduced power consumption for the specific frame times. FIG. 7 illustrates example waveforms for image transitions where a part of the drive pulse in the transitions from W to G1, and from G2 to G1, is delayed by two frame periods, in accordance with a second embodiment of the invention. Waveform 700 provides an image transition from White (W) to Dark grey (G1), waveform 720 provides an image transition from Black (B) to Light grey (G2), waveform 740 provides an image transition from G2 to G1, and waveform 760 provides an image transition from G2 to G2. The same waveforms as used in FIG. 5 are presented, but now part of the greyscale drive pulses (D2) in both the W to G1 transition (waveform 700) and the G2 to G1 transition (waveform 740) is delayed by two frames. In particular, for the waveform 700, the drive portion includes a first drive portion (D1), followed by a delay of one or more frame times, followed by a second drive portion (D2). The waveform 740 similarly includes first and second drive portions D1 and D2, respectively. Again, for the short frame time (FT′) frames, the waveforms are configured so that the voltage levels vary only within a subset range of possible values. For example, between t₀ and t₁, and between t₁ and t₂, the voltage levels only vary between 0 V and +15 V since the waveforms 700, 720, 740 and 760 request 0 V, +15 V, 0 V and 0 V, respectively.

Between t₂ and t₃, the voltage levels only vary between −15 V and 0 V since the waveforms 700, 720, 740 and 760 request −15 V, 0 V, −15 V and 0 V, respectively. Between t₃ and 4, and between t₄ and t₅, the voltage levels only vary between −15 V and 0 V since the waveforms 700, 720, 740 and 760 request −15 V, 0 V, 0 V and 0 V, respectively.

In the third and fourth frame (between to and t₂), two scans, each with a frame time of FT′, or one scan with a frame time of 2 FT′ may be used. In the fifth frame, between t₂ and t₃, a single scan with the minimum FT is used. In the sixth and seventh frames, between t3 and t5, two scans, each with a frame time of FT′, or one scan with a frame time of 2 FT′ may be used.

FIG. 8 illustrates example waveforms for image transitions where a part of the drive pulse in the transitions from W to G1, and from G2 to G1, is delayed by three frame periods, in accordance with a third embodiment of the invention. Waveform 800 provides an image transition from White (W) to Dark grey (G1), waveform 820 provides an image transition from Black (B) to Light grey (G2), waveform 840 provides an image transition from G2 to G1, and waveform 860 provides an image transition from G2 to G2. The third embodiment is derived from the second embodiment, but an additional frame is added. In particular, relative to the corresponding waveforms of FIG. 7, an additional frame with V=0 is used after the completion of the positive drive pulse in the B to G2 transition (waveform 800) and the G2 to G2 transition (waveform 860), and prior to the start of the negative drive pulses (D2) in the W to G1 and G2 to G1 transitions (waveforms 800 and 840, respectively). In particular, in waveform 800, the second portion of the drive pulse (D2) is delayed by three frames instead of two frames from the first portion of the drive pulse (D1).

In waveform 820, an additional frame with V=0 is provided following the drive portion (D).

In waveform 840, the second portion of the drive pulse (D2) is delayed by three frames instead of two frames from the first portion of the drive pulse (D1). In waveform 860, an additional frame with V=0 is provided following the drive portion (D). This approach may further reduce the time-averaged load of the source driver, thereby further reducing time-averaged power consumption.

Note that, in the above examples, pulse-width modulated (PWM) driving is used for illustrating the invention, where the pulse time is varied in each waveform while the voltage amplitude is kept constant. However, the invention is also applicable to other driving schemes, e.g., based on voltage modulated driving (VM), where the pulse voltage amplitude is varied in each waveform, or combined PWM and VM driving. The invention is applicable to color as well as greyscale bi-stable displays. Also, the electrode structure is not limited. For example, a top/bottom electrode structure, honeycomb structure, an in-plane switching structure or other combined in-plane-switching and vertical switching may be used. Moreover, the invention may be implemented in passive matrix as well as active matrix electrophoretic displays. In fact, the invention can be implemented in any bi-stable display that does not consume power while the image substantially remains on the display after an image update. Also, the invention is applicable to both single and multiple window displays, where, for example, a typewriter mode exists.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A method for providing a set of voltage waveforms for updating at least a portion of a bi-stable display in successive frame periods, the method comprising:
accessing data defining the set of voltage waveforms for the successive frame periods; and
generating the set of voltage waveforms (600, 620, 640, 660; 700, 720, 740, 760; 800, 820, 840, 860) for driving the at least a portion of the bi-stable display (310) during the successive frame periods according to the accessed data; wherein:
over a duration of the successive frame periods, each of the voltage waveforms spans a first range of values; and
at least one of the successive frame periods is time-aligned with a data-dependent portion of each of the voltage waveforms that spans a second range of values that is a subset of the first range of values.

2. The method of claim 1, wherein:
at least one other of the successive frame periods is time-aligned with a data-dependent portion of each of the voltage waveforms that spans a third range of values that is a subset of the first range of values.

3. The method of claim 2, wherein:
the second and third ranges of values are contiguous and span the first range of values.

4. The method of claim 1, wherein:
a relatively shorter frame period (FT′) is used during the at least one of the successive frame periods.

5. The method of claim 1, wherein:
the data-dependent portion of each of the voltage waveforms comprises a reset portion (R).

6. The method of claim 1, wherein:
the data-dependent portion of each of the voltage waveforms comprises a drive portion (D, D1, D2).

7. The method of claim 1, wherein:
the data-dependent portion of each of the voltage waveforms comprises a first drive portion (D1), followed by a delay, followed by a second drive portion (D2).

8. The method of claim 1, wherein:
the bi-stable display comprises an electrophoretic display.

9. The method of claim 1, further comprising:
lowering a supply voltage of a voltage source used for the generating of the set of voltage waveforms during the at least one of the successive frame periods, from a supply voltage associated with the first range of values to a supply voltage associated with the second range of values.

10. A program storage device tangibly embodying a program of instructions executable by a machine to perform a method for providing a set of voltage waveforms for updating at least a portion of a bi-stable display in successive frame periods, the method comprising:
accessing data defining the set of voltage waveforms for the successive frame periods; and
generating the set of voltage waveforms (600, 620, 640, 660; 700, 720, 740, 760; 800, 820, 840, 860) for driving the at least a portion of the bi-stable display (310) during the successive frame periods according to the accessed data; wherein:
over a duration of the successive frame periods, each of the voltage waveforms spans a first range of values; and
at least one of the successive frame periods is time-aligned with a data-dependent portion of each of the voltage waveforms that spans a second range of values that is a subset of the first range of values.

11. The program storage device of claim 10, wherein:
at least one other of the successive frame periods is time-aligned with a data-dependent portion of each of the voltage waveforms that spans a third range of values that is a subset of the first range of values.

12. The program storage device of claim 10, wherein:
a relatively shorter frame period (FT′) is used during the at least one of the successive frame periods.

13. The program storage device of claim 10, wherein:
the data-dependent portion of each of the voltage waveforms comprises at least one of a reset portion (R) and a drive portion (D, D1, D2).

14. The program storage device of claim 10, wherein:
the bi-stable display comprises an electrophoretic display.

15. The program storage device of claim 10, wherein the method further comprises:
lowering a supply voltage of a voltage source used for the generating of the set of voltage waveforms during the at least one of the successive frame periods, from a supply voltage associated with the first range of values to a supply voltage associated with the second range of values.

16. An display device, comprising:
a bi-stable display (310); and
a control (100) for providing a set of voltage waveforms for updating at least a portion of a bi-stable display (310) in successive frame periods by: (a) accessing data defining the set of voltage waveforms for the successive frame periods, and (b) generating the set of voltage waveforms (600, 620, 640, 660; 700, 720, 740, 760; 800, 820, 840, 860) for driving the at least a portion of the bi-stable display during the successive frame periods according to the accessed data; wherein:
over a duration of the successive frame periods, each of the voltage waveforms spans a first range of values; and
at least one of the successive frame periods is time-aligned with a data-dependent portion of each of the voltage waveforms that spans a second range of values that is a subset of the first range of values.

17. The display device of claim 16, wherein:
a relatively shorter frame period (FT′) is used during the at least one of the successive frame periods.

18. The display device of claim 16, wherein:
the data-dependent portion of each of the voltage waveforms comprises at least one of a reset portion (E) and a drive portion (D, D1, D2).

19. The display device of claim 16, wherein:
the bi-stable display comprises an electrophoretic display.

20. The display device of claim 16, wherein:
the control lowers a supply voltage of a voltage source used for the generating of the set of voltage waveforms during the at least one of the successive frame periods, from a supply voltage associated with the first range of values to a supply voltage associated with the second range of values.

21. A controller (100) comprising means for accessing data defining a set of voltage waveforms (600, 620, 640, 660; 700, 720, 740, 760; 800, 820, 840, 860) for updating at least a portion of a bi-stable display (310) in successive frame periods and comprising an arithmetic logic circuit configured to generate the set of voltage waveforms (600, 620, 640, 660; 700, 720, 740, 760; 800, 820, 840, 860) for driving the at least a portion of the bi-stable display during the successive frame periods according to the accessed data; wherein:
over a duration of the successive frame periods, each of the voltage waveforms spans a first range of values; and
at least one of the successive frame periods is time-aligned with a data-dependent portion of each of the voltage waveforms that spans a second range of values that is a subset of the first range of values.
